(19) United States
(12) Patent Application Publication
(10) Pub. No.: US 2013/0151355 A1
(43) Pub. Date: Jun. 13, 2013

(54) SYSTEMS AND METHODS FOR ORDERING GOODS OR SERVICES

(71) Applicants: Michael Abromovitz, Bethel Park, PA (US); Jordan Abromovitz, Bethel Park, PA (US)

(72) Inventors: Michael Abromovitz, Bethel Park, PA (US); Jordan Abromovitz, Bethel Park, PA (US)

(73) Assignee: IDINING, INC., Bethel Park, PA (US)

(21) Appl. No.: 13/323,170

(22) Filed: Dec. 12, 2011

(51) Int. Cl. G06Q 50/12; G06Q 20/40; G06Q 20/08

(52) U.S. Cl. 705/15; 705/24; 705/44

(57) ABSTRACT

A method of fulfilling an order may include receiving identifying information associated with a user, receiving delivery information, displaying one or more cuisine types available for ordering, receiving a selection of one of the one or more cuisine types, displaying one or more food types associated with the selected cuisine type and receiving a selection of one of the one or more food types. The method may include displaying one or more items associated with the selected food type, receiving a selection of one of the one or more items, receiving a selection of a payment method from a user and receiving payment from the user. The method may include transmitting information associated with an order to an order receiving device, and printing, by the order placement device, a receipt associated with the order.

### BACKGROUND

Employees often do not have a broad variety of lunch options from which to choose. This is especially true for employees whose place of employment does not have a cafeteria or other lunch option or whose place of employment is not located within walking distance from restaurants or other food providers. In addition, whatever limited options that are available to those wishing to purchase lunch are usually extremely busy given the amount of demand.

### SUMMARY

In an embodiment, a method of fulfilling an order may include receiving, by an order placement device, identifying information associated with a user. The identifying information may include a name associated with the user. The method may include receiving, by the order placement device, delivery information. The delivery information may include a delivery time. The method may include displaying, by the order placement device, one or more cuisine types available for ordering, receiving, by the order placement device, a selection of one of the one or more cuisine types, displaying, by the order placement device, one or more food types associated with the selected cuisine type and receiving a selection of one of the one or more food types. The method may include displaying one or more items associated with the selected food type, receiving a selection of one of the one or more items, receiving a selection of a payment method from a user and receiving payment from the user. The payment may correspond to the selected payment method. The method may include transmitting information associated with an order to an order receiving device, and printing, by the order placement device, a receipt associated with the order. The order may include an indication of the selected items, the identifying information and the delivery information.

In an embodiment, a method of fulfilling an order may include receiving, by an order placement device, identifying information associated with a user, receiving, by the order placement device, delivery information, receiving, by the order placement device, a selection of one or more items to order, and receiving a selection of a payment method from a user. The method may include receiving payment from the user, transmitting an order to an order receiving device, and printing, by the order placement device, a receipt associated with the order. Payment may correspond to the selected payment method and the order may include an indication of the selected items, the identifying information and the delivery information.

In an embodiment, a system for fulfilling an order may include an order placement device comprising a processor and a processor-readable storage medium in communication with the processor. The processor-readable storage medium may include one or more programming instructions, that when executed, cause the processor to receive, identifying information associated with a user, delivery information, a selection of one or more items to order, a selection of a payment method from a user and payment from the user. Payment may correspond to the selected payment method. The processor-readable storage medium may include one or more programming instructions, that when executed, cause the processor to transmit an order to an order receiving device, and print a receipt associated with the order. The order may include an indication of the selected items, the identifying information and the delivery information.

A system for fulfilling an order may comprise an order placement device in communication with a plurality of order receiving devices. The order placement device may be located remotely from each of the plurality of order receiving devices. The order placement device may include a processor, a printing device, a payment device, and a computer-readable storage medium in communication with the processor. The computer-readable storage medium may include one or more programming instructions that, when executed, cause the processor to receive identifying information associated with a user, delivery information, and display a plurality of items available to order. The plurality of items may include a first item and a second item. The first item may be available to order from a first vendor, and the second item may be available to order from a second vendor. The computer-readable storage medium may include one or more programming instructions that, when executed, cause the processor to receive a selection of one or more items to order from the displayed items, a selection of a payment method from a user, and receive, at the payment device, payment from the user. Payment may correspond to the selected payment method. The computer-readable storage medium may include one or more programming instructions that, when executed, cause the processor to transmit an order to one or more order receiving devices, and print, at the printing device, a receipt associated with the order. The order may include an indication of the selected items, the identifying information and the delivery information.

### BRIEF DESCRIPTION OF THE DRAWINGS

FIG. 1A illustrates an example system for placing an order according to an embodiment.

FIG. 1B illustrates an example of an order placement device according to an embodiment.

FIG. 1C illustrates an example system for placing an order according to an embodiment.

FIG. 2 illustrates an example of a method of placing an order according to an embodiment.

FIG. 3 illustrates an example of a screen through which a user may enter identifying information according to an embodiment.

FIG. 4A illustrates an example of a screen that may be displayed to a user on an order placement device according to an embodiment.

FIG. 4B illustrates examples of subcategories according to an embodiment.

FIG. 4C illustrates examples of items according to an embodiment.

FIG. 4D illustrates an example of delivery times that may be displayed to a user according to an embodiment.

FIG. 4E illustrates an example of a payment option screen that may be displayed to a user according to an embodiment.

FIG. 5 depicts a block diagram of exemplary hardware that may be used to contain or implement program instructions according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

For the purposes of this application, the following terms shall have the respective meanings set forth below:

A “computing device” refers to an electronic device that performs one or more operations according to one or more programming instructions.

An “order placement device” refers to a computing device that is configured to receive an order for goods and/or services from a user. An order placement device may include, without limitation, a computer, an internet kiosk, a personal digital assistant, a cellular telephone, a mobile device, a desktop computer, a laptop computer, a tablet computer and/or the like.

An “order receiving device” refers to a computing device that is configured to receive and/or access, directly or indirectly, an order of goods and/or services from an order placement device. An order receiving device may include, without limitation, a computer, an internet kiosk, a personal digital assistant, a cellular telephone, a mobile device, a desktop computer, a laptop computer, a tablet computer, and/or the like.

A “payment service” is a facility that manages the transfer of funds from a customer to a provider of goods and/or services.

The term “remote,” as used herein with respect to computing devices, refers to devices that operate on different computer networks and/or computer networks operated by different entities. For example, a first computing device is remote from a second computing device if the first computing device is connected to a first LAN operated by a first entity and the second computing device is connected to a second LAN operated by a second entity.

A “vendor” is a person, entity, group, organization and/or the like that provides goods and/or services.

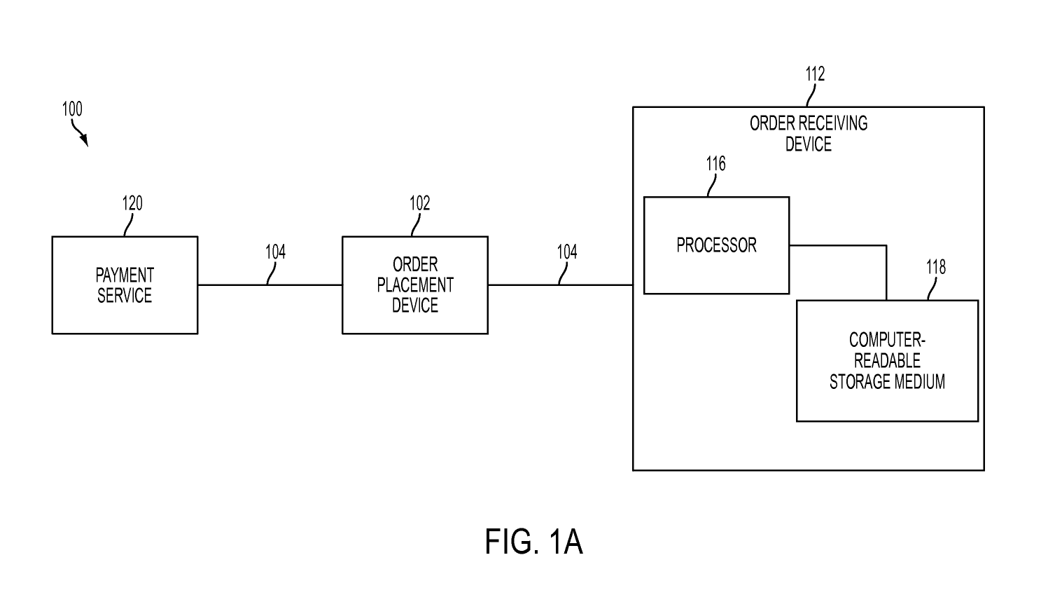

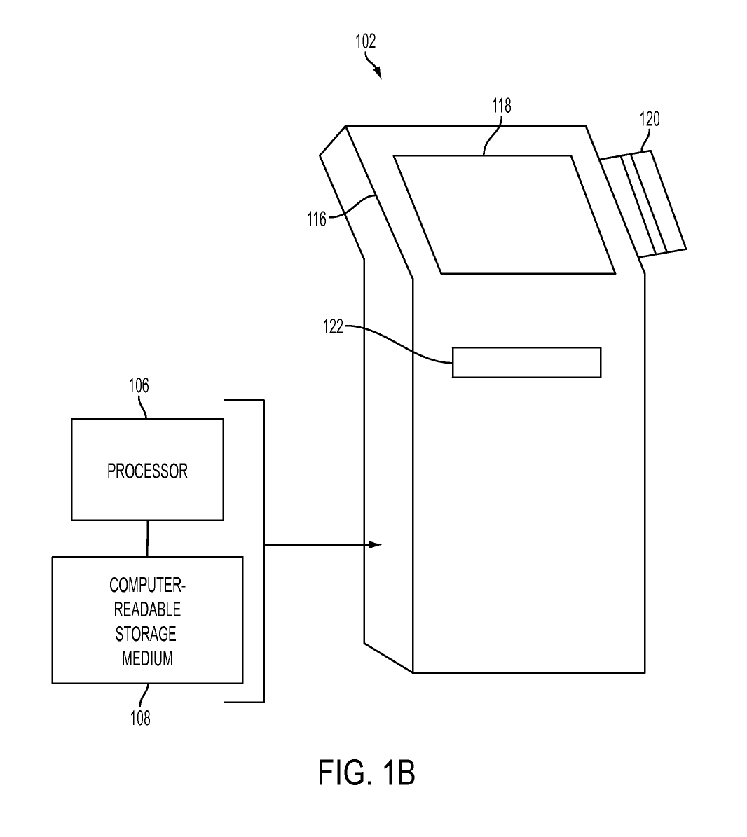

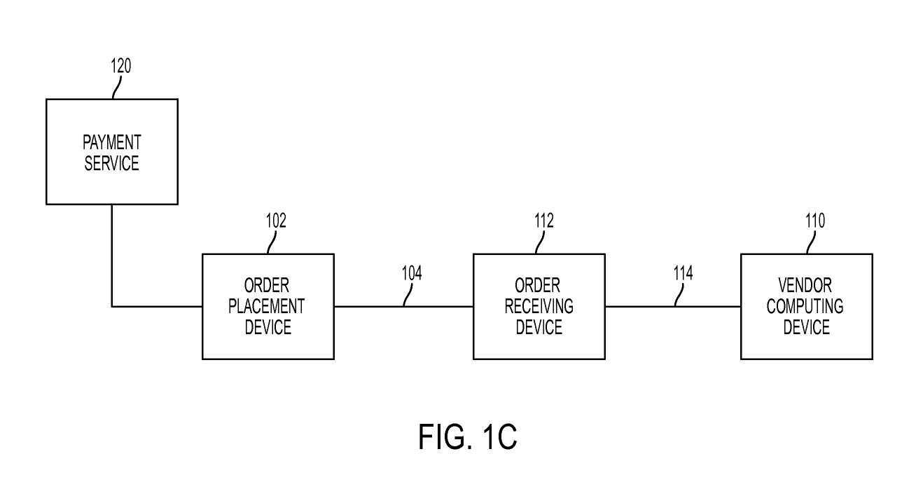

FIG. 1A illustrates an example system 100 for placing an order according to an embodiment. In an embodiment, one or more order placement devices 102 may communicate with one or more order receiving devices 112 over one or more communication networks 104.

FIG. 1B illustrates an example of an order placement device 102 according to an embodiment. As illustrated by FIG. 1B, an order placement device 102 may include a processor 106 and/or a computer-readable storage medium 108. In an embodiment, an order placement device 102 may include a display device 116 such as a screen, a touch screen and/or the like. In an embodiment, an order placement device 102 may include an input device 118 such as a keyboard, a touch pad, a mouse, a joy stick, a touch screen and/or the like. In an embodiment, an order placement device 102 may include a print device 122. A print device may include a printer according to an embodiment. In an embodiment, an order placement device 102 may include a payment device 120. A payment device 120 may include a card swiper, a cash insertion mechanism, a coin insertion mechanism, a biometric payment device, a barcode reader, a scanner and/or the like. In an embodiment, an order placement device may be located in an office building, a school facility, a college or university facility, a hotel, an apartment building and/or the like.

Referring back to FIG. 1A, a communication network 104 may be a local area network (LAN), a wide area network (WAN) and/or the like. For example, a communication network 104 may be an extranet, an intranet, the Internet and/or the like. In an embodiment, a communication network 104 may provide communication capability between one or more of the order placement devices 102 and one or more of the order receiving devices 112.

In an embodiment, an order receiving device 112 may include a processor 116 in communication with a computer-readable storage medium 118. In an embodiment, an order receiving device 112 may include a display device.

In an embodiment, an order placement device 102 may be in communication with one or more payment services 120. A payment service 120 may be a credit or debit card company, a bank, a credit union and/or the like.

FIG. 1C illustrates an example system for placing an order according to an embodiment. As illustrated by FIG. 1C, one or more order placement devices 102 may be in communication with a central computing device via one or more communication networks. A central computing device may be a server or other processing device. A central computing device may be in communication with one or more order receiving devices 102 via one or more communication networks 104.

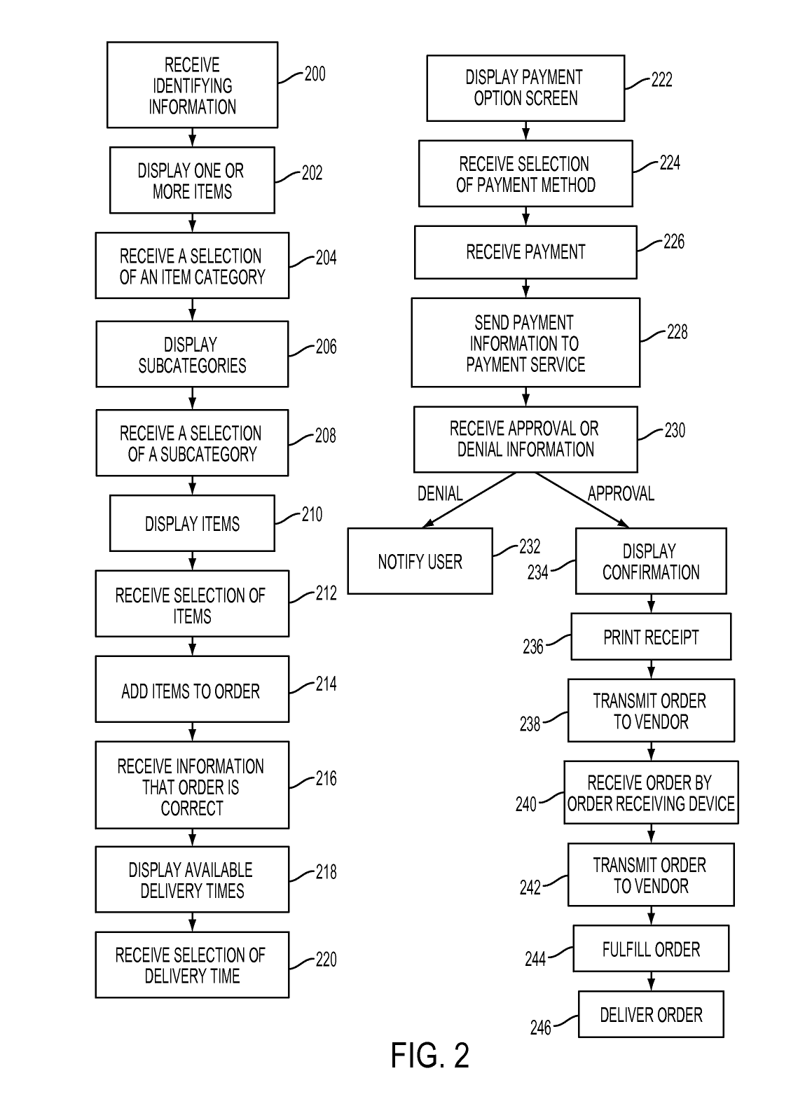

FIG. 2 illustrates an example of a method of placing an order according to an embodiment. An order may include a request for the provision of goods and/or services. For example, an order may be an order for food, beverages and/or the like. Although the examples presented herein relate to the ordering of food and drinks, it is understood that additional goods and/or services such as, by way of example, flowers, plants, clothing and/or the like, may be used within the scope of this disclosure.

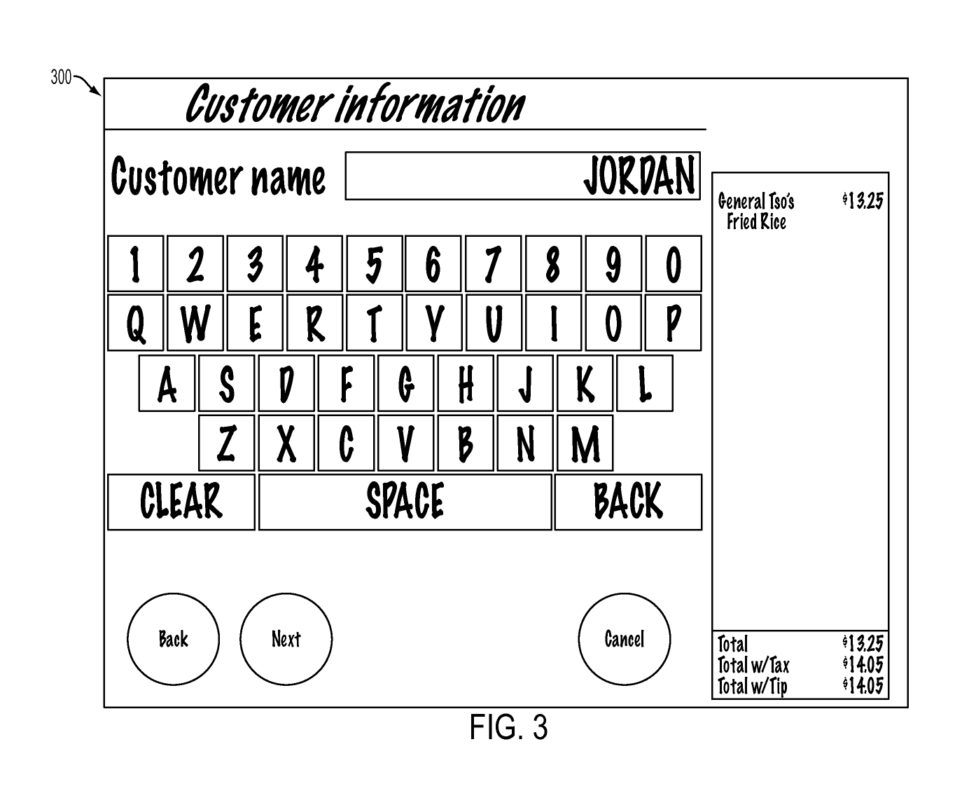

As illustrated in FIG. 2, an order placement device may receive 200 identifying information from a user. For example, a user may provide his or her name, company name, information associated with his or her location and/or the like. For example, a user may place an order for lunch using an order placement device located in or near the user's place of employment. The user may provide his or her name, company name, building number, suite number and/or the like. FIG. 3 illustrates an example of a screen 300 through which a user may enter identifying information according to an embodiment.

In an embodiment, one or more items may be displayed 202 to a user. In an embodiment, one or more suggested items may be displayed 202 to a user. A suggested item may be based on the provided identifying information. For example, an order placement device may maintain a record of one or more past orders placed by the user. The order placement device may display 202 one or more suggestions based on the user's past order history. For example, if a user has ordered a sandwich the past two orders, an order placement device may display 202 one or more sandwich options to the user. Similarly, if a user has ordered Italian food in the past, the order placement device may display 202 one or more suggested Italian offerings. In an embodiment, an entire menu of available offerings may be displayed 202 to a user.

In an embodiment, one or more displayed items may be associated with certain vendors. For example, menu items for distinct vendors may be displayed to a user of an order placement device. Distinct vendors may refer to vendors that are distinct entities or are otherwise unaffiliated. For example, an order placement device may display menu offerings from a Chinese restaurant and from a sandwich restaurant that are unaffiliated. In an embodiment, distinct vendors may refer to vendors that operate separate establishments. For example, a commonly owned and/or operated Chinese restaurant and Japanese restaurant may be distinct vendors, and menu offerings for each may be displayed on an order placement device.

In an embodiment, menu offerings for only certain vendors may be displayed at an order placement device. For example, menu offerings of one or more vendors that are located a certain distance away from the location of the order management device may be displayed. By way of example, menu offerings of vendors located within fifteen miles from an order placement device may be displayed at the order placement device according to an embodiment. Additional and/or alternate distances may be used within the scope of this disclosure.

As illustrated by FIG. 2, an order placement device may receive 204 a selection of an item category associated with one or more items to order. In an embodiment, an item category may be a type associated with an item, such as a classification by vendor, origin, use, function and/or the like. For example, if an item to be ordered is food, an item category may be type of cuisine, restaurant or other merchant, ingredients and/or the like.

In an embodiment, a selection may be received 204 from a user via an input device associated with the order placement device. For example, if an order placement device includes a touch screen, a selection of an item category may be received 204 in response to a user touching one or more portions of the touch screen. In an embodiment, a selection of one or more items to order may be received 204 in response to a user pressing one or more keys on a keyboard or a touch pad associated with the order placement device.

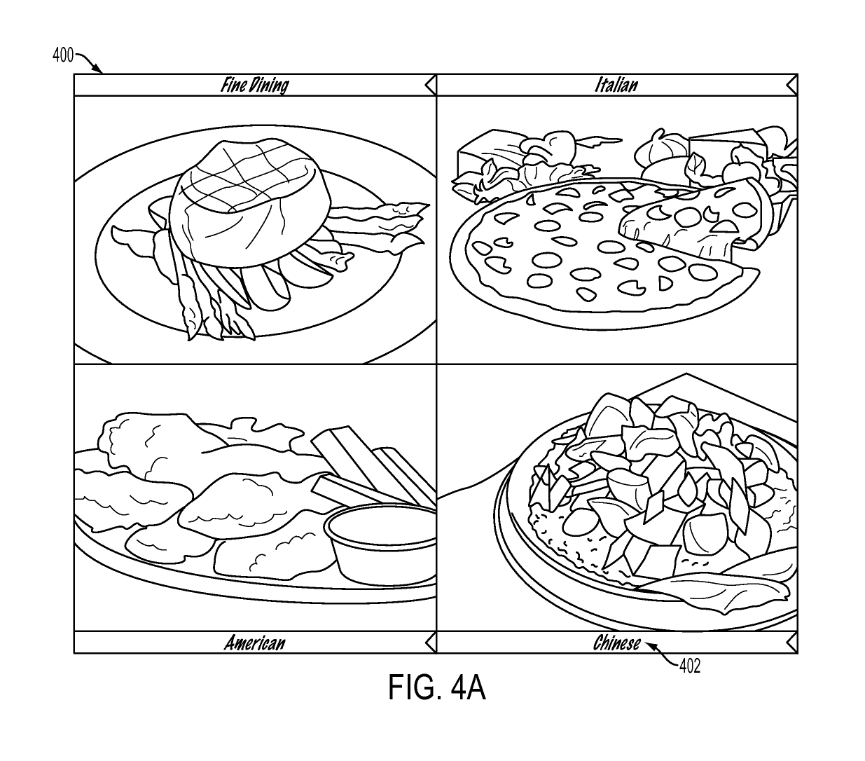

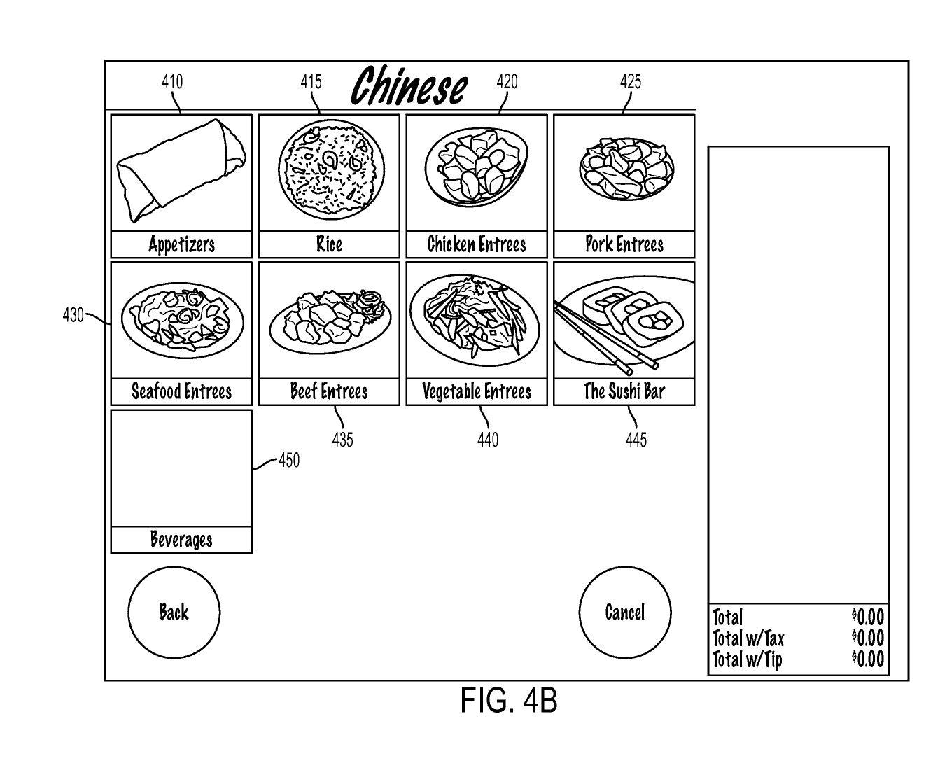

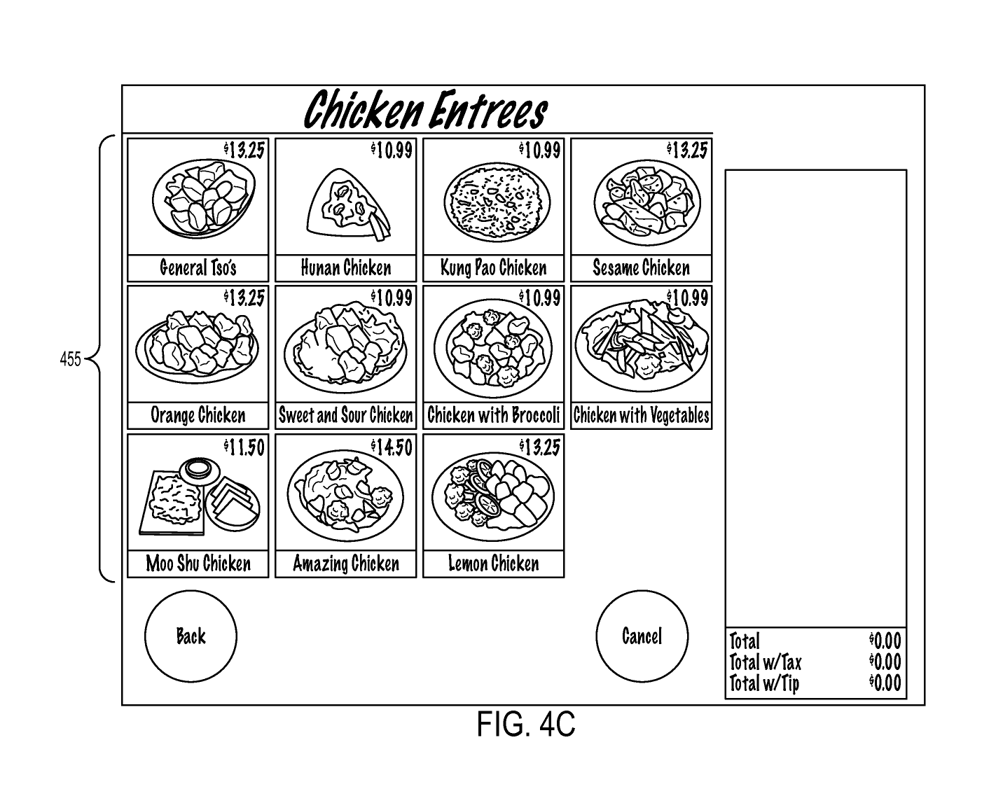

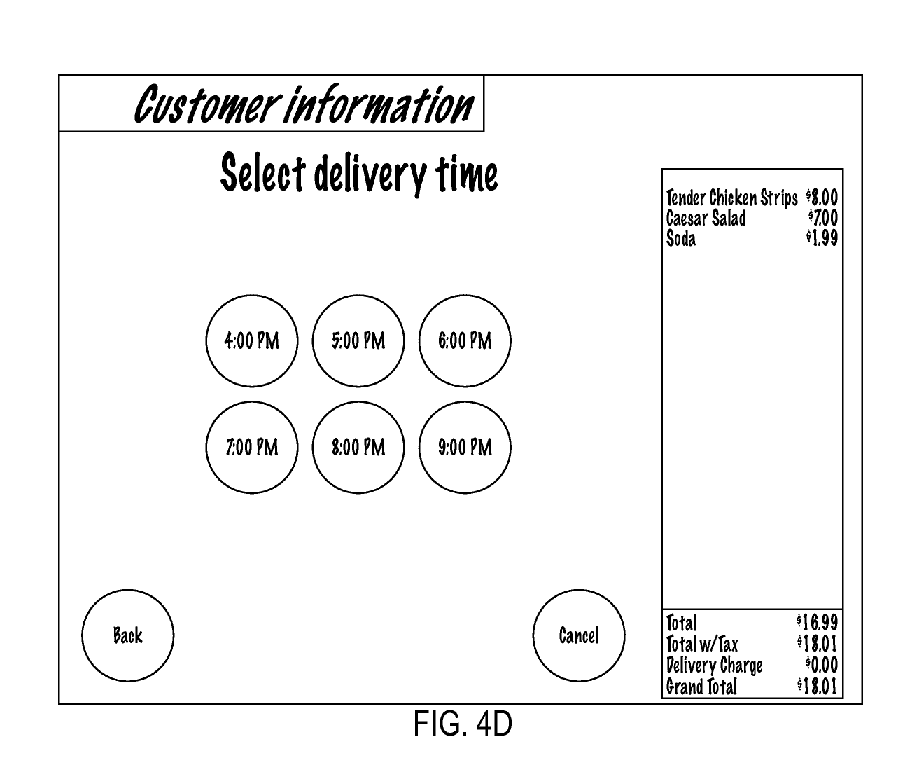

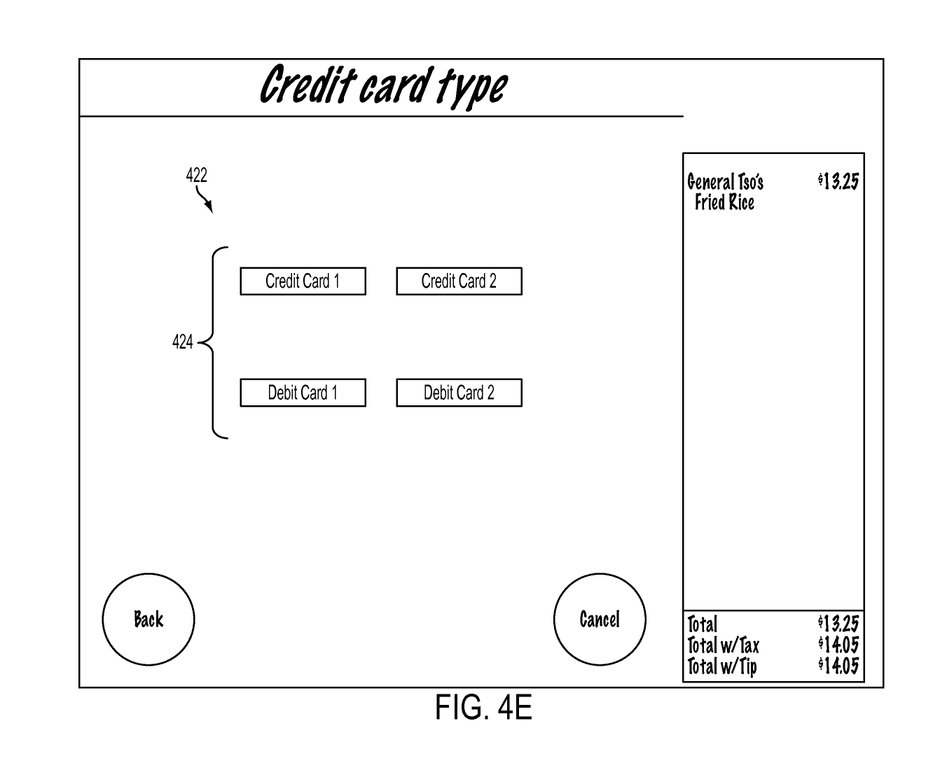

FIG. 4A illustrates an example of a screen that may be displayed to a user on an order placement device according to an embodiment. FIG. 4A illustrates examples of types of food 400 that a user may order. In an embodiment, a user may touch the picture, icon, text or other indication associated with the category of food the user would like to order to proceed with his or her order. For example, if a user would like to order Chinese food, the user may touch the picture associated with Chinese food 402 located on the bottom left side of the screen illustrated in FIG. 4A.

In an embodiment, one or more subcategories associated with the selected item category may be displayed 206. FIG. 4B illustrates examples of subcategories associated with the Chinese food category according to an embodiment. As illustrated by FIG. 4B, subcategories may include appetizers 410, rice 415, chicken entrees 420, pork entrees 425, seafood entrees 430, beef entrees 435, vegetable entrees 440, sushi 445 and beverages 450.

In an embodiment, a selection of a sub-category may be received 208 from a user. In an embodiment, a user may touch the picture, icon, text or other indication associated with the sub-category. For example, if a user would like to order a chicken entree, the user may touch the picture associated with the chicken entrée 420 on the screen as illustrated in FIG. 4B.

In an embodiment, one or more items within a selected subcategory may be displayed 210 to a user. For example, FIG. 4C illustrates examples of items 455 that may be displayed 210 if the subcategory chicken entrees 420 is selected. As illustrated by FIG. 4C, the displayed items 455 may all correspond to the selected subcategory. For example, each of the items 455 displayed in FIG. 4C are chicken entrees.

In an embodiment, a selection of one or more displayed items may be received 212 from a user. The selected items may be added 214 to an order to be placed on behalf of the user. In an embodiment, an order may include one or more items from a plurality of different subcategories within the same category. For example, a user may order an appetizer, a chicken entrée and a beverage from a certain category. In an embodiment, an order may include one or more items from a plurality of different subcategories within different categories. For example, a user may order an appetizer from an Italian category and may order an entrée from a Chinese category.

In an embodiment, a user may be asked to confirm that one or more items in an order is correct. For example, a screen may be displayed to a user that identifies one or more items within a current order. The user may have the option to edit the items within the current order. For example, the user may have the option to add one or more items, remove one or more items, change a quantity of one or more items, change a preference associated with one or more items and/or the like. In an embodiment, a user may be required to make a selection to confirm that an order is correct. For example, a user may be required to press a button, click or press an icon on the screen and/or the like to confirm the accuracy of an order. This selection may be received 216 by an order placement device.

In an embodiment, a user may provide information regarding delivery of the order. For example, a user may provide a preferred delivery time, a delivery location and/or the like. In an embodiment, an order placement device may display 218 one or more available delivery times from which a user can choose. FIG. 4D illustrates an example of a delivery time screen that may be displayed to a user according to an embodiment. As illustrated by FIG. 4D, one or more available delivery times may be displayed to a user.

In an embodiment, an available delivery time may depend on the time the order is placed, the item or items within an order, the vendor from which an item is being purchased and/or the like. For example, an order may take at least forty-five minutes to be prepared and delivered. In this situation, if the user places an order at 11:00 A.M., the first available delivery time that may be displayed to the user may be 11:45 A.M. Additional and/or alternate time periods may be used within the scope of this disclosure.

In an embodiment, one or more available delivery times may be within a certain time period. For example, lunch orders may be available for delivery between 11:30 A.M. and 1:30 P.M. In an embodiment, available delivery times may occur at certain intervals. For example, available delivery times may occur every fifteen minutes. Additional and/or alternate time periods may be used within the scope of this disclosure.

In an embodiment, a user may specify a particular delivery time and date. For example, a user may want to order lunch for the next day. The user may specify a delivery date of the following day at a certain time. In an embodiment, an order placement device may prohibit a user from placing orders a certain time period in advance. For example, a user may only be able to place orders 24 hours in advance. Additional and/or alternate time periods may be used within the scope of this disclosure. In an embodiment, a selection of a delivery time may be received 220 by an order placement device.

In an embodiment, a user may select a payment method. In an embodiment, a payment option screen may be displayed 222 to a user. FIG. 4E illustrates an example of a payment option screen that may be displayed to a user. A payment option screen 422 may include information about one or more payment methods accepted by the order placement device. In an embodiment, payment methods may include payment by credit card, debit card, coupon, loyalty card, gift card, cash, check and/or the like. For example, as illustrated by FIG. 4E, icons 424 associated with one or more credit card types that are accepted by the order placement device may be displayed 222.

In an embodiment, a user may select an icon or other identifier associated with a desired payment method. For example, if a user would like to pay using Credit Card 1 as illustrated in FIG. 4E, the user may select the icon on the display associated with Credit Card 1. A user may select the icon using an input method associated with an order placement device, such as by pressing one or more keys on a keyboard, selecting the icon using a mouse, touching the icon on a screen and/or the like. In an embodiment, a selection of a payment method may be received 224 by an order placement device. In an embodiment, a user may adjust a payment amount. For example, a user may adjust a payment amount by adding a tip to the order amount.

In an embodiment, a user may render payment at an order placement device. Payment may be received 226 by an order placement device. For example, a user may swipe a credit, debit or other payment card. In an embodiment, a user may scan a credit, debit or other payment card. A user may insert cash into an order placement device. In an embodiment, a user may have an option to place an order without rendering payment at the order placement device. For example, a user may have an option to defer payment until the order is received by the user.

In an embodiment, if payment is rendered using a credit or debit card, card information associated with the credit or debit card used may be sent 228 to a payment service in response to the card being swiped, scanned or otherwise processed by an order placement device. The payment service may verify and/or authenticate the card, and an order placement device may receive 230 approval or denial information to the order placement device. If the order placement device receives 230 denial information, the order placement device may notify 232 the user. For example, the order placement device may display a notice to the user that the payment method was denied. The order placement may ask the user to try rendering payment again. In an embodiment, the order placement device may end or cancel a transaction in response to receiving denial information.

In an embodiment, an order placement device may display 234 a confirmation to a user in response to payment being successfully rendered. For example, an order placement device may display 234 a confirmation to a user in response to receiving approval information from a payment service. In an embodiment, an order placement device may print 236 one or more receipts. In an embodiment, the order placement device may print 236 a receipt containing the user's name, items that the user ordered, cost associated with the ordered items, total cost, order time, delivery time, vendor, location, confirmation number or code and/or the like. In an embodiment, an order placement device may print 236 a receipt that the user must sign. For example, if a user pays for an order using a credit card, the order placement device may print a credit card receipt for the user to sign. The user may be required to present a signed copy of the receipt to the vendor upon delivery of the order.

In an embodiment, a payment service may authorize payment for the order to an operator of the order placement device. In an embodiment, a payment service may transfer funds in the amount of the order to an account associated with the operator of an order placement device from which the order was placed. For example, if a user pays for an order costing $10.25 using a debit card, a payment service associated with the debit card, such as a user's bank, may transfer $10.25 to an account associated with the operator of the order placement device from which the order was placed.

In an embodiment, the operator of the order placement device may render payment to the vendor or vendors from whom one or more items in the order were ordered. In an embodiment, the operator of the order placement device may retain a portion of the amount received from a user for an order and may transfer the remaining amount to a vendor. For example, if the user's order in the amount of $10.25 was for a meal from a Chinese restaurant, the operator of the order placement device may retain a certain portion of the $10.25 for its services, and may transfer the remaining amount to the Chinese restaurant. In an embodiment, an amount retained by an operator of an order placement device may be a certain percentage of the total transaction. For example, if an operator retains 10% of a total charge, the operator may retain $1.02 of a $10.25 order, and may transfer payment of $9.23 to an account associated with the Chinese restaurant.

In an embodiment, an amount retained by an operator of an order placement device may be a flat fee. For example, an operator may retain $2.00 from every transaction. For example, the operator may retain $2.00 of a $10.25 order, and may transfer payment of $8.25 to an account associated with the Chinese restaurant.

In an embodiment, an amount rendered to a vendor may be deducted by credit or debit card processing fees, taxes, or other fees. For example, an order costing $10.25 that is paid for using a credit card may incur a 1% credit card processing fee. If an operator retains 10% of a total charge, the operator may retain $1.02. The amount the vendor is to receive (i.e., $9.23) may be reduced by the credit card processing fee (i.e., $0.10). As such, a vendor may receive $9.13.

In an embodiment, a vendor may pay an operator of an order placement device a certain amount to be included as a vendor on the order placement device. For example, a vendor may pay an operator a monthly payment in order to be included on an order placement device. Additional and/or alternate payments may be made within the scope of this disclosure.

In an embodiment, an order may be transmitted 238 to one or more vendors offering the goods or services that comprise an order. For example, if a user orders an entrée from a Chinese restaurant, the order may be transmitted 238 to the Chinese restaurant. In an embodiment, if an order includes items from different vendors, the order may be transmitted 238 to each of the vendors.

In an embodiment, an order may include the item or items ordered, the identifying information, a unique identifier associated with the order placement device, information regarding delivery of the order, and/or the like. A unique identifier associated with the order placement device may identify a location of the order placement device. For example, each order placement device may have a corresponding unique identifier. The unique identifier may be associated with a particular location. For example, an order placement device in Building A of an office park may be associated with one unique identifier while an order placement device in Building B of the office park may be associated with another unique identifier. When a vendor receives an order, the vendor may be able to discern the delivery location based on the unique identifier. For example, if a vendor receives an order from the order placement device having the unique identifier associated with the order placement device in Building B, the vendor may know to deliver the order to Building B.

In an embodiment, an order may be received 240 by an order receiving device. An order receiving device may be a computing device located at a vendor's location. For example, a vendor may have a receiver, a processor, a monitor and/or the like. An order from a vendor may be sent from the order placement device to the vendor's order receiving device. In an embodiment, an order receiving device may be located remotely from an order placement device. For example, an order placement device may be located in the lobby of an office building while an order receiving device may be located within a restaurant that is not on the premises of the office building. In an embodiment, an order may be displayed on a display device of an order receiving device. The order may be automatically displayed on a display device of an order receiving device when the order is received by the order receiving device.

In an embodiment, an order receiving device may receive an order from an order placement device via a central computing device. A central communication device may receive an order from an order placement device and may make the order available to an order receiving device. For example, a central communication device may receive an order for Chinese food from a particular Chinese food vendor from an order placement device. The central communication device may store information relating to the order in a database or other memory associated with the communication device. The vendor may access details of the order by communicating with the central communication device. For example, a vendor may have an account that a vendor may access to view order information. For instance, a vendor may visit a webpage and provide account information, such as a unique user name, password and/or the like. The vendor may be able to view order information that has been received for the vendor. In an embodiment, a vendor may access a software application on the vendor computing device in order to view one or more orders for the vendor. The software application may communicate with the order placement device to allow a vendor to view one or more orders.

In an embodiment, an order receiving device may communicate with one or more order placement devices via a first communication network. In an embodiment, an order receiving device may communicate with a central computing device via a second communication network. In an embodiment, an order receiving device may communicate with a central computing device via the same communication that the central computing device may use to communication with an order placement device. For example, an order receiving device may communicate with a central computing device via the Internet, and a central computing device may communicate with one or more order receiving devices via the Internet.

In an embodiment, a central computing device may transmit 242 an order to a vendor providing ordered goods and/or services. For example, if a user orders an entrée from a Chinese restaurant, the order may be transmitted from an order placement device to a central computing device. The central computing device may transmit 242 the order to an order receiving device associated with the applicable vendor.

In an embodiment, a vendor may fulfill 244 one or more orders. In an embodiment, a vendor may deliver the items within an order. A vendor may deliver 246 the items within an order within a time period. For example, if a user specifies a delivery time of 12:30 P.M., the vendor may deliver 246 the order by 12:30 P.M. In an embodiment, a vendor may deliver 246 the items within an order to the location specified in the order. In an embodiment, upon delivery, the vendor may require a user to present his or her receipt in order to accept the order. In an embodiment, if a user opted to defer payment until delivery, the vendor may obtain payment for the order from the user upon delivery.

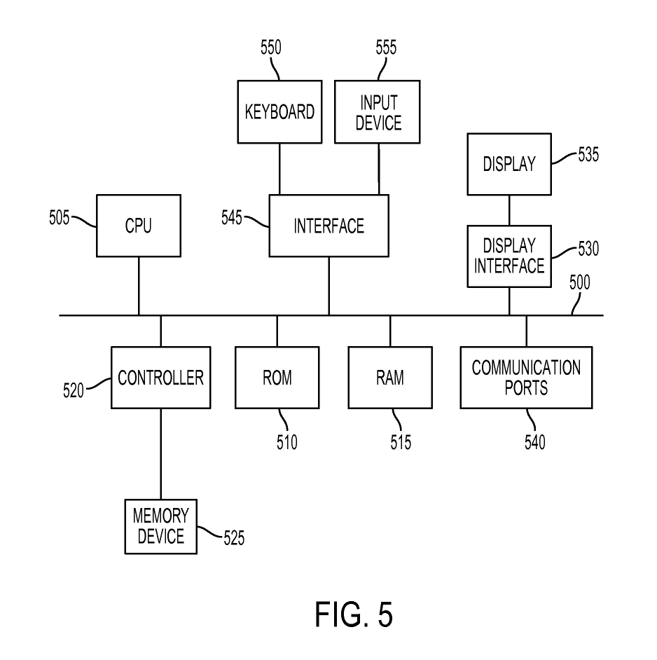

FIG. 5 depicts a block diagram of exemplary hardware that may be used to contain or implement program instructions according to an embodiment. A bus 500 serves as the main information highway interconnecting the other illustrated components of the hardware. CPU 505 is the central processing unit of the system, performing calculations and logic operations required to execute a program. Read only memory (ROM) 510 and random access memory (RAM) 515 constitute exemplary memory devices.

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices.

Program instructions may be stored in the ROM 510 and/or the RAM 515. Optionally, program instructions may be stored on a tangible computer readable storage medium such as a hard disk, compact disk, a digital disk, flash memory, a memory card, a USB drive, an optical disc storage medium, such as Blu-ray™ disc, and/or other recording medium.

An optional display interface 530 may permit information from the bus 500 to be displayed on the display 535 in audio, visual, graphic or alphanumeric format. Communication with external devices may occur using various communication ports 540. An exemplary communication port 540 may be attached to a communications network, such as the Internet or an intranet.

The hardware may also include an interface 545 which allows for receipt of data from input devices such as a keyboard 550 or other input device 555 such as a mouse, a joystick, a touch screen, a remote control, a pointing device, a video input device and/or an audio input device.

What is claimed is:

1. A method of fulfilling an order, the method comprising:
receiving, by an order placement device, identifying information associated with a user, wherein the identifying information comprises a name associated with the user;
receiving, by the order placement device, delivery information, wherein the delivery information comprises a delivery time;
displaying, by the order placement device, one or more cuisine types available for ordering;
receiving, by the order placement device, a selection of one of the one or more cuisine types;
displaying, by the order placement device, one or more food types associated with the selected cuisine type;
receiving a selection of one of the one or more food types;
displaying one or more items associated with the selected food type;
receiving a selection of one of the one or more items;
receiving a selection of a payment method from a user;
receiving payment from the user, wherein payment corresponds to the selected payment method;
transmitting information associated with an order to an order receiving device, wherein the order comprises an indication of the selected items, the identifying information and the delivery information; and
printing, by the order placement device, a receipt associated with the order.

2. The method of claim 1, wherein receiving delivery information comprises:
displaying one or more available delivery times; and
receiving a selection of a delivery time from the one or more available delivery times that are displayed.

3. The method of claim 2, wherein displaying one or more available delivery time comprises:
determining a current time;
displaying one or more available delivery times, each of which occur after a time period; and
receiving a selection of a delivery time from the one or more available delivery times that are displayed.

4. The method of claim 1, wherein receiving payment from the user comprises:
receiving payment card information, wherein the payment card information comprises information associated with a credit card or a debit card;
transmitting the payment card information to a payment service;
receiving, from the payment service, an indication of whether the payment card information was denied or approved;
in response to receiving an indication that the payment card information was denied, displaying, by the order placement device, a notification to the user; and
in response to receiving an indication that the payment card information was approved, displaying, by the order placement device, a confirmation of the order.

5. The method of claim 1, wherein transmitting an order to an order receiving device comprises transmitting a unique identifier associated with the order placement device to the order receiving device, wherein the unique identifier is associated with a location of the order placement device.

6. The method of claim 1, wherein transmitting an order to an order receiving device comprises transmitting an order to an order receiving device associated with a vendor that corresponds to the selected items.

7. The method of claim 1, wherein displaying one or more cuisine types available for ordering comprises displaying one or more cuisine types, wherein each cuisine type is associated with a different vendor.

8. The method of claim 1, wherein transmitting information associated with an order to an order receiving device comprises transmitting information associated with an order to an order receiving device that is located remotely from the order placement device.

9. A method of fulfilling an order, the method comprising:
receiving, by an order placement device, identifying information associated with a user;
receiving, by the order placement device, delivery information;
receiving, by the order placement device, a selection of one or more items to order;
receiving a selection of a payment method from a user;
receiving payment from the user, wherein payment corresponds to the selected payment method;
transmitting an order to an order receiving device, wherein the order comprises an indication of the selected items, the identifying information and the delivery information; and
printing, by the order placement device, a receipt associated with the order.

10. The method of claim 9, wherein receiving information associated with delivery from a user comprises:
displaying one or more available delivery times; and
receiving a selection of a delivery time from the one or more available delivery times that are displayed.

11. The method of claim 10, wherein displaying one or more available delivery time comprises:
determining a current time;
displaying one or more available delivery times, each of which occur after a time period; and
receiving a selection of a delivery time from the one or more available delivery times that are displayed.

12. The method of claim 9, wherein receiving a selection of one or more items to order comprises:
displaying one or more categories of items;
receiving a selection of a category from the one or more displayed categories;
displaying one or more subcategories associated with the selected category;
receiving a selection of a subcategory from the one or more displayed subcategories;
displaying one or more items corresponding to the subcategory; and
receiving a selection of one or more items from the one or more displayed items.

13. The method of claim 9, wherein receiving a selection of one or more items to order comprises:
identifying one or more past orders placed by the user using the identifying information;
determining one or more suggested items based on the one or more past orders; and
displaying one or more of the suggested items.

14. The method of claim 9, wherein receiving payment from the user comprises:
receiving payment card information, wherein the payment card information comprises information associated with a credit card or a debit card;
transmitting the payment card information to a payment service;
receiving, from the payment service, an indication of whether the payment card information was denied or approved;
in response to receiving an indication that the payment card information was denied, displaying, by the order placement device, a notification to the user; and
in response to receiving an indication that the payment card information was approved, displaying, by the order placement device, a confirmation of the order.

15. The method of claim 9, wherein transmitting an order to an order receiving device comprises transmitting a unique identifier associated with the order placement device to the order receiving device, wherein the unique identifier is associated with a location of the order placement device.

16. The method of claim 9, wherein transmitting an order to an order receiving device comprises transmitting an order to an order receiving device associated with a vendor that corresponds to the selected items.

17. The method of claim 9, wherein receiving a selection of one or more items to order comprises displaying a first item and a second item, wherein the first item is provided by a first vendor and the second item is provided by a second vendor.

18. The method of claim 9, wherein transmitting information associated with an order to an order receiving device comprises transmitting information associated with an order to an order receiving device that is located remotely from the order placement device.

19. A system for fulfilling an order, the system comprising:
an order placement device comprising a processor and a processor-readable storage medium in communication with the processor, wherein the processor-readable storage medium comprises one or more programming instructions, that when executed, cause the processor to:
receive identifying information associated with a user,
receive identifying information associated with a user,
receive delivery information,
receive a selection of one or more items to order,
receive a selection of a payment method from a user,
receive payment from the user, wherein payment corresponds to the selected payment method,
transmit an order to an order receiving device, wherein the order comprises an indication of the selected items, the identifying information and the delivery information, and
print a receipt associated with the order.

20. The system of claim 19, wherein the one or more programming instructions that, when executed, cause the processor to receive information associated with delivery comprises one or more programming instructions that, when executed, cause the processor to:
display one or more available delivery times; and
receive a selection of a delivery time from the one or more available delivery times that are displayed.

21. The system of claim 19, wherein the one or more programming instructions that, when executed, cause the processor to receive a selection of one or more items to order comprise one or more programming instructions that, when executed, cause the processor to:
display one or more categories of items;
receive a selection of a category from the one or more displayed categories;
display one or more subcategories associated with the selected category;
receive a selection of a subcategory from the one or more displayed subcategories;
display one or more items corresponding to the subcategory; and
receive a selection of one or more items from the one or more displayed items.

22. The system of claim 19, wherein the one or more programming instructions that, when executed, cause the processor to transmit an order comprise one or more programming instructions that, when executed, cause the processor to transmit a unique identifier associated with the order placement device to the order receiving device, wherein the unique identifier is associated with a location of the order placement device.

23. The system of claim 19, in the one or more programming instructions that, when executed, cause the processor to transmit an order comprise one or more programming instructions that, when executed, cause the processor to transmit an order to an order receiving device associated with a vendor that corresponds to the selected items.

24. A system for fulfilling an order, the system comprising:
an order placement device in communication with a plurality of order receiving devices, wherein the order placement device is located remotely from each of the plurality of order receiving devices, wherein the order placement device comprises:
a processor,
a printing device,
a payment device, and
a computer-readable storage medium in communication with the processor, wherein the computer-readable storage medium comprises one or more programming instructions that, when executed, cause the processor to:
receive identifying information associated with a user,
receive delivery information,
display a plurality of items available to order, wherein the plurality of items comprises a first item and a second item, wherein the first item is available to order from a first vendor, wherein the second item is available to order from a second vendor,
receive a selection of one or more items to order from the displayed items, receive a selection of a payment method from a user,
receive, at the payment device, payment from the user, wherein payment corresponds to the selected payment method,
transmit an order to one or more order receiving devices, wherein the order comprises an indication of the selected items, the identifying information and the delivery information, and
print, at the printing device, a receipt associated with the order.
